(19) United States
(12) Patent Application Publication
(10) Pub. No.: US 2019/0094484 A1
(43) Pub. Date: Mar. 28, 2019

(54) INFRARED LENS MODULE

(71) Applicant: Sumitomo Electric Industries, Ltd., Osaka-shi (JP)

(72) Inventors: Masato Hasegawa, Osaka-shi (JP); Ryota Yamaguchi, Osaka-shi (JP); Akinori Kahara, Osaka-shi (JP)

(73) Assignee: Sumitomo Electric Industries, Ltd., Osaka-shi (JP)

(21) Appl. No.: 16/085,075

(22) PCT Filed: Mar. 10, 2017
(86) PCT No.: PCT/JP2017/009845

§ 371 Date: Sep. 14, 2018

(30) Foreign Application Priority Data
Mar. 15, 2016 (JP) 2016-051680
Jul. 1, 2016 (JP) 2016-131645

(51) Int. Cl. G02B 7/02; G02B 13/14

(52) U.S. Cl. CPC G02B 7/028; G02B 13/14

(57) ABSTRACT

An infrared lens module includes a lens that transmits infrared rays, a lens barrel that holds the lens, and a temperature adjustment device that is disposed on the lens and adjusts the temperature of the lens.

### TECHNICAL FIELD

The present invention relates to an infrared lens module.

This application claims the priority based on Japanese Patent Application No. 2016-051680 filed on Mar. 15, 2016 and Japanese Patent Application No. 2016-131645 filed on Jul. 1, 2016, the entire contents of which are incorporated herein by reference.

### BACKGROUND ART

As a countermeasure in the case where an infrared camera is used in a low-temperature environment, there is proposed a structure in which an infrared camera is housed in a case having a window that transmits infrared rays and condensation and freezing are prevented by heating the window with a heater (see, for example, Japanese Unexamined Patent Application Publication No. 2001-57642 (PTL 1)).

### CITATION LIST

### Patent Literature

PTL 1: Japanese Unexamined Patent Application Publication No. 2001-57642

### SUMMARY OF INVENTION

An infrared lens module according to the present invention includes a lens that transmits infrared rays, a lens barrel that holds the lens, and a temperature adjustment device that is disposed on the lens and adjusts the temperature of the lens.

### BRIEF DESCRIPTION OF DRAWINGS

FIG. 1 is a schematic sectional view showing the structure of an infrared lens module according to an embodiment 1.

FIG. 2 is a schematic sectional view showing the structure of an infrared lens module according to an embodiment 2.

FIG. 3 is a schematic sectional view showing the structure of an infrared lens module according to an embodiment 3.

FIG. 4 is a schematic sectional view showing the structure of an infrared lens module according to an embodiment 4.

FIG. 5 is a schematic sectional view showing the structure of an infrared lens module according to an embodiment 5.

FIG. 6 is a schematic sectional view showing the structure of an infrared lens module according to an embodiment 6.

FIG. 7 is a schematic sectional view showing the structure of an infrared lens module according to an embodiment 7.

FIG. 8 is a schematic sectional view showing the structure of an infrared lens module according to an embodiment 8.

FIG. 9 is a schematic sectional view showing the structure of an infrared lens module according to an embodiment 9.

FIG. 10 is a schematic sectional view showing the structure of an infrared lens module according to an embodiment 10.

FIG. 11 is a schematic sectional view showing the structure of an infrared lens module according to an embodiment 11.

### DESCRIPTION OF EMBODIMENTS

### Problem to be Solved by Present Disclosure

The structure disclosed in PTL 1 does not adjust the temperature of the infrared lens but adjusts the temperature of the window of the case. Therefore, a case having a window that transmits infrared rays is indispensable, the size of the device increases, and the cost rises. Therefore, it is an object to provide an infrared lens module that can easily adjust the temperature of an infrared lens.

### Advantageous Effects of Present Disclosure

According to the infrared lens module of the present disclosure, it is possible to provide an infrared lens module that can easily adjust the temperature of an infrared lens.

### Description of Embodiments of Present Invention

First, embodiments of the present invention will be listed and described. An infrared lens module according to a first aspect of the present application includes a lens that transmits infrared rays, a lens barrel that holds the lens, and a temperature adjustment device that is disposed on the lens and adjusts the temperature of the lens.

In the infrared lens module according to the first aspect of the present application, the temperature adjustment device that adjusts the temperature of the lens is disposed on the lens. Since, instead of placing the temperature adjustment device outside the infrared lens module and adjusting the temperature of the lens from the outside, the temperature of the lens is adjusted by the temperature adjustment device disposed on the lens, the lens is easily adjusted to a desired temperature. As described above, according to the infrared lens module of the present application, it is possible to provide an infrared lens module that can easily adjust the temperature of an infrared lens.

In the infrared lens module according to the first aspect, a space may be formed between the lens and the lens barrel. By doing so, heat conduction to the lens barrel is suppressed, and the temperature of the infrared lens is more easily adjusted.

In the infrared lens module according to the first aspect, the temperature adjustment device may be disposed on at least one of the outer peripheral surface of the lens and the outer edge region of the lens surface. By doing so, the temperature adjustment device can be easily placed.

In the infrared lens module according to the first aspect, the material constituting the lens may be zinc sulfide (ZnS). In the lens made of ZnS, the change in refractive index with temperature change is small. Therefore, by employing a lens made of ZnS in the lens module of the present application, the focal position of the lens is easily set within a desired range.

An infrared lens module according to a second aspect of the present application includes a lens that transmits infrared rays and a lens barrel that holds the lens. The lens barrel includes a lens barrel main body and a cap disposed on one end side of the lens barrel main body. The lens is held between the lens barrel main body and the cap. A heater that adjusts the temperature of the lens is placed in the cap.

In the infrared module according to the second aspect of the present application, the heater is placed in the cap that holds the lens. Since, instead of adjusting the temperature of the lens from the outside of the infrared lens module, the temperature of the lens is adjusted by the heater placed in the cap, the lens is easily adjusted to a desired temperature. As described above, according to the infrared lens module of the present application, it is possible to provide an infrared lens module that can easily adjust the temperature of a lens.

In the infrared lens module according to the second aspect, a region of the lens barrel main body that contacts the lens may be made of a material having a thermal conductivity lower than that of a region of the cap that contacts the lens. By doing so, heat conduction to the lens barrel main body is suppressed, and the temperature of the lens is more easily adjusted.

In the infrared lens module according to the second aspect, the emissivity of the surface of the cap other than the surface exposed to the outside may be 0.7 or less. By doing so, the amount of heat radiation from the cap is reduced, and the temperature of the lens is more easily adjusted. From the viewpoint of easier adjustment of the temperature of the lens, the emissivity is preferably 0.5 or less, and more preferably 0.3 or less.

In the infrared lens module according to the second aspect, the material constituting the lens may be zinc sulfide. In the lens made of ZnS, the change in refractive index with temperature change is small. Therefore, by employing a lens made of ZnS in the lens module of the present application, the focal position of the lens is easily set within a desired range.

### Details of Embodiments of Present Invention

Next, an embodiment of the infrared lens module according to the present invention will be described below with reference to the drawings. In the following drawings, the same or corresponding parts are denoted by the same reference numerals, and the description thereof will not be repeated.

### Embodiment 1

FIG. 1 is a schematic sectional view showing a cross section including the optical axis of a lens module according to an embodiment 1. Referring to FIG. 1, a lens module 1 according to the embodiment 1 includes a lens 10, a lens barrel 50, and a heater 61.

The lens 10 is an infrared lens that transmits infrared rays, more specifically light having a wavelength of 8 μm or more and 14 μm or less. The material constituting the lens 10 is, for example, ZnS. The lens 10 includes a first lens surface 11, a second lens surface 12, and an outer peripheral surface 13. The first lens surface 11 includes a central region 11A that is a convex surface located in the center and intersecting with the optical axis C, and an outer edge region 11B that is a flat surface surrounding the central region 11A. The second lens surface 12 includes a central region 12A that is a concave surface located in the center and intersecting with the optical axis C, and an outer edge region 12B that is a flat surface surrounding the central region 12A.

The lens barrel 50 includes a cap 20 and a lens barrel main body 30. The lens barrel main body 30 has a cylindrical shape. The lens barrel main body 30 contacts the outer edge region 12B of the second lens surface 12 and the outer peripheral surface 13 at the end thereof to support the lens 10. In the present embodiment, the lens barrel main body 30 is made of resin or metal such as aluminum alloy.

The cap 20 has a cylindrical shape in which a protruding portion 21 protruding radially inward is formed at one end. The cap 20 is made of metal such as aluminum alloy. A space is formed between the inner peripheral surface 22 of the cap 20 and the outer peripheral surface 13 of the lens 10. In addition, the protruding portion 21 of the cap 20 and the outer edge region 11B of the first lens surface 11 are in contact with each other. Further, a space is formed between a region on the outer periphery side of a region of the protruding portion 21 that contacts the outer edge region 11B and the outer edge region 11B. Further, the cap 20 is fixed to the lens barrel main body 30 in a state where it is fitted to the end of the barrel main body 30 at the end thereof opposite to the side where the protruding portion 21 is formed. In this manner, the lens 10 is held by the lens barrel 50.

The heater 61 as a temperature adjustment device that adjusts the temperature of the lens 10 is fixed to the outer peripheral surface 13 of the lens 10. The heater 61 is disposed within the space formed between the outer peripheral surface 13 of the lens 10 and the inner peripheral surface 22 of the cap 20. The heater 61 is disposed on the outer peripheral surface 13 of the lens 10 so as to extend along the circumferential direction. The heater 61 may be disposed so as to contact over the entire circumference of the outer peripheral surface 13. A wire 62 is connected to the heater 61. The wire 62 is connected to a power supply (not shown). The heater 61 driven by electric power supplied from the power supply via the wire 62 adjusts the temperature of the lens 10 by heating the lens 10. The heater 61 is, for example, a film heater.

In the lens module 1 that is the infrared lens module of the present embodiment, the heater 61 that adjusts the temperature of the lens 10 is fixed to the outer peripheral surface 13 of the lens 10. Since, instead of placing the heater 61 outside the lens module 1 and adjusting the temperature of the lens 10 from the outside, the temperature of the lens 10 is adjusted (heated) by the heater 61 fixed to the lens 10, the lens 10 is easily adjusted to a desired temperature. Furthermore, in the present embodiment, a space is formed between the lens 10 and the lens barrel 50 (cap 20). Consequently, heat conduction to the cap 20 is suppressed, and the temperature of the lens 10 is more easily adjusted. As described above, the lens module 1 of the present embodiment is an infrared lens module that can easily adjust the temperature of the lens 10. Further, the lens barrel main body 30 that contacts the lens 10 can be made of resin. By using resin, which has thermal conductivity lower than that of metal, as a material constituting the lens barrel main body 30 that contacts the lens 10, heat conduction to the lens barrel main body 30 is suppressed, and the temperature of the lens 10 is more easily adjusted.

### Embodiment 2

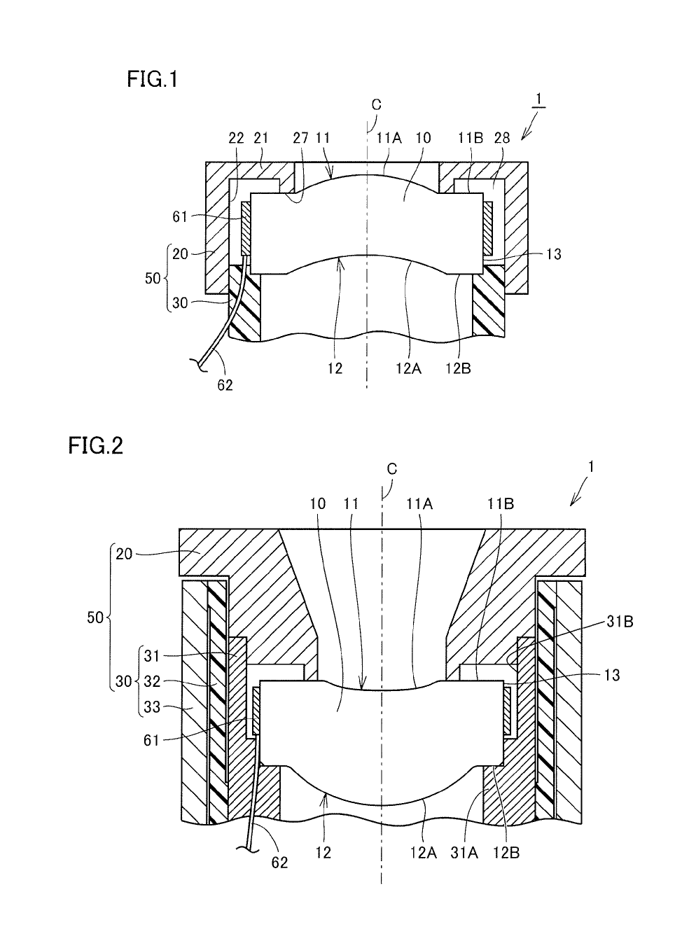

Next, an embodiment 2 which is another embodiment will be described. FIG. 2 is a schematic sectional view showing a cross section including the optical axis of a lens module according to the embodiment 2.

Referring to FIG. 2, the lens module 1 according to the embodiment 2 includes a lens 10, a lens barrel 50, and a heater 61.

The lens 10 is an infrared lens that transmits infrared rays. The material constituting the lens 10 is, for example, ZnS. The lens 10 includes a first lens surface 11, a second lens surface 12, and an outer peripheral surface 13. The first lens surface 11 includes a central region 11A that is a concave surface located in the center and intersecting with the optical axis C, and an outer edge region 11B that is a flat surface surrounding the central region 11A. The second lens surface 12 includes a central region 12A that is a convex surface located in the center and intersecting with the optical axis C, and an outer edge region 12B that is a flat surface surrounding the central region 12A.

The lens barrel 50 includes a cap 20 and a lens barrel main body 30. The lens barrel main body 30 has a cylindrical shape. The lens barrel main body 30 includes a cylindrical inner cell 31, a middle cell 32 surrounding the outer periphery of the inner cell 31, and an outer cell 33 surrounding the outer periphery of the middle cell 32. The inner cell 31 and the outer cell 33 are made of metal such as aluminum alloy, for example. The middle cell 32 is made of resin, for example. A space is formed between the inner peripheral surface 31B of the inner cell 31 and the outer peripheral surface 13 of the lens 10. In a region on the second lens surface 12 side of a region of the outer peripheral surface 13 of the lens 10 between which and the inner peripheral surface 31B of the inner cell 31 a space is formed, the inner peripheral surface 31B of the inner cell 31 and the outer peripheral surface 13 of the lens 10 contact each other. Further, a protruding portion 31A protruding inwardly is formed in the inner cell 31. The protruding portion 31A of the inner cell 31 and the outer edge region 12B of the second lens surface 12 contact each other.

The cap 20 has a cylindrical shape. The cap 20 is made of metal such as aluminum alloy. The cap 20 contacts the outer edge region 11B of the first lens surface 11 at one end face. Further, a space is formed between a region on the outer periphery side of a region of the cap 20 that contacts the outer edge region 11B and the outer edge region 11B. Further, the cap 20 is fixed to the lens barrel main body 30 in a state where it is fitted to the end of the barrel main body 30 in a region on the outer periphery side of a region of the cap 20 between which and the outer edge region 11B a space is formed. In this manner, the lens 10 is held by the lens barrel 50.

In the lens module 1 that is the infrared lens module of the present embodiment, the heater 61 that adjusts the temperature of the lens 10 is fixed to the outer peripheral surface 13 of the lens 10. Since, instead of placing the heater 61 outside the lens module 1 and adjusting the temperature of the lens 10 from the outside, the temperature of the lens 10 is adjusted (heated) by the heater 61 fixed to the lens 10, the lens 10 is easily adjusted to a desired temperature. Furthermore, in the present embodiment, a space is formed between the lens 10 and the lens barrel 50 (inner cell 31). Consequently, heat conduction to the inner cell 31 is suppressed, and the temperature of the lens 10 is more easily adjusted. As described above, the lens module 1 of the present embodiment is an infrared lens module that can easily adjust the temperature of the lens 10.

In the embodiment 2, the inner cell 31 is made of metal, but the inner cell 31 may be made of resin. By using resin, which has thermal conductivity lower than that of metal, as a material constituting the inner cell 31 that contacts the lens 10, heat conduction to the inner cell 31 is suppressed, and the temperature of the lens 10 is more easily adjusted.

### Embodiment 3

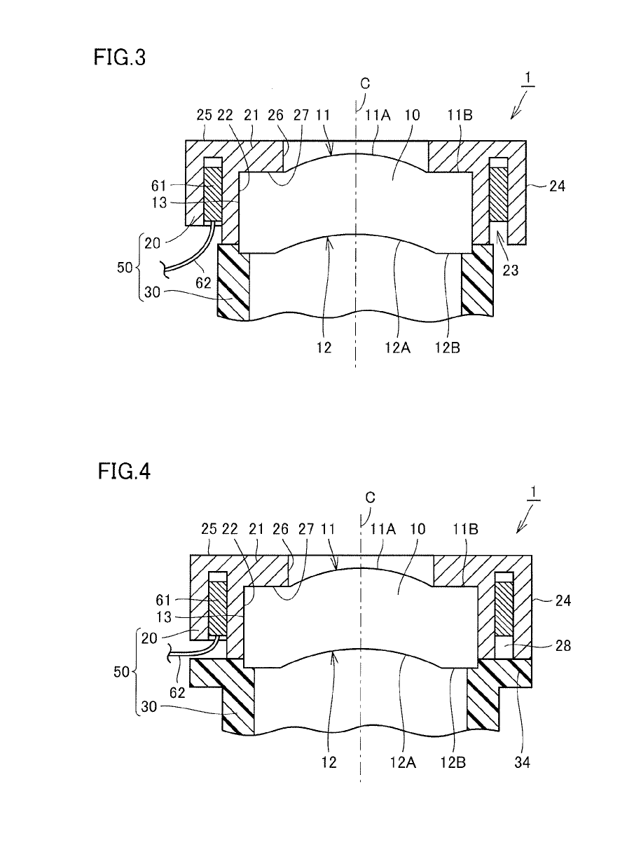

Next, an embodiment 3 which is another embodiment will be described. FIG. 3 is a schematic sectional view showing a cross section including the optical axis of a lens module according to the embodiment 3. Referring to FIG. 3, the lens module 1 according to the embodiment 3 includes a lens 10, a lens barrel 50, and a heater 61.

The lens 10 is an infrared lens that transmits infrared rays, more specifically light having a wavelength of 8 μm or more and 14 μm or less. The material constituting the lens 10 is, for example, ZnS. The lens 10 includes a first lens surface 11, a second lens surface 12, and an outer peripheral surface 13. The first lens surface 11 includes a central region 11A that is a convex surface located in the center and intersecting with the optical axis C, and an outer edge region 11B that is a flat surface surrounding the central region 11A. The second lens surface 12 includes a central region 12A that is a concave surface located in the center and intersecting with the optical axis C, and an outer edge region 12B that is a flat surface surrounding the central region 12A.

The lens barrel 50 includes a cap 20 and a lens barrel main body 30. The lens barrel main body 30 has a cylindrical shape. The lens barrel main body 30 contacts the outer edge region 12B of the second lens surface 12 and the outer peripheral surface 13 at the end thereof to support the lens 10.

The cap 20 has a cylindrical shape in which a protruding portion 21 protruding radially inwardly is formed at one end. The cap 20 is made of metal such as aluminum alloy. The inner peripheral surface 22 of the cap 20 and the outer peripheral surface 13 of the lens 10 contact each other. In addition, the protruding portion 21 of the cap 20 and the outer edge region 11B of the first lens surface 11 contact each other. The cap 20 is disposed on one end side of the lens barrel main body 30. The cap 20 is fixed in contact with the lens barrel main body 30 at the end thereof opposite to the side where the protruding portion 21 is formed. In this manner, the lens 10 is held between the lens barrel main body 30 and the cap 20 and held by the lens barrel 50.

An annular groove portion 23 is formed in the cap 20 so as to penetrate in the axial direction from the end face opposite to the side where the protruding portion 21 is formed. The heater 61 that adjusts the temperature of the lens 10 is placed inside the groove portion 23. The heater 61 is fixed in contact with the side wall of the groove portion 23. The heater 61 is disposed so as to extend along the circumferential direction of the annular groove portion 23. The heater 61 may be disposed so as to contact over the entire circumference of the side wall of the groove portion 23. A wire 62 is connected to the heater 61. The wire 62 is connected to a power supply (not shown). The heater 61 driven by electric power supplied from the power supply via the wire 62 adjusts the temperature of the lens 10 by heating the lens 10. The heater 61 is, for example, a film heater.

In the lens module 1 that is the infrared lens module of the present embodiment, the heater 61 that adjusts the temperature of the lens 10 is fixed in the groove portion 23 formed in the cap 20. Since, instead of placing the heater 61 outside the lens module 1 and adjusting the temperature of the lens 10 from the outside, the temperature of the lens 10 is adjusted (heated) by the heater 61 fixed to the cap 20, the lens 10 is easily adjusted to a desired temperature.

Further, in the lens module 1, a region of the lens barrel main body 30 that contacts the lens 10 is preferably made of a material having a thermal conductivity lower than that of a region of the cap 20 that contacts the lens 10. In the present embodiment, the cap 20 is made of metal, specifically aluminum alloy, and the lens barrel main body 30 is made of resin, which is a material having a thermal conductivity lower than that of the metal constituting the cap 20. Consequently, heat conduction between the lens 10 and the lens barrel main body 30 is suppressed, and the temperature of the lens 10 is more easily adjusted.

Further, in the lens module 1, the emissivity of the surface of the cap 20 other than the surface exposed to the outside is preferably 0.7 or less. A black alumite layer is formed on the inner peripheral surface 26 of the protruding portion 21, the end face 25 on the protruding portion 21 side, and the outer peripheral surface 24, which are surfaces exposed to the outside in the cap 20 of the present embodiment. The black alumite layer can be formed by introducing a black dye into pores of an alumite layer (oxide layer) formed by alumite treatment after alumite treatment (anodic oxidation treatment). Since the black alumite layer is formed, the emissivity of these surfaces, which are the surfaces exposed to the outside, exceeds 0.7. On the other hand, the black alumite layer is not formed on at least a part of the lens holding surface 27, which is a surface of the protrusion portion 21 in contact with the lens 10, and at least a part of the inner peripheral surface 22, which are surfaces other than the surfaces exposed to the outside in the cap 20. On the lens holding surface 27, which is a surface of the protruding portion 21 in contact with the lens 10, and the inner peripheral surface 22, metal such as aluminum alloy that is a material constituting the cap 20 may be exposed, or a surface treatment layer having lower emissivity than the alumite layer may be exposed. As a result, the emissivity of the lens holding surface 27, which is a surface of the protruding portion 21 in contact with the lens 10, and the inner peripheral surface 22 is 0.7 or less. Consequently, the amount of heat radiation from the cap 20 is reduced, and the temperature of the lens 10 is more easily adjusted. From the viewpoint of easier adjustment of the temperature of the lens 10, the emissivity is preferably 0.5 or less, and more preferably 0.3 or less.

### Embodiment 4

Next, an embodiment 4 which is another embodiment will be described. FIG. 4 is a schematic sectional view showing a cross section including the optical axis of a lens module according to the embodiment 4. Referring to FIGS. 4 and 3, the lens module 1 according to the embodiment 4 basically has the same configuration and effects as those of the embodiment 3. However, the lens module 1 of the embodiment 4 differs from the embodiment 3 in the structure of the lens barrel main body 30.

Referring to FIG. 4, the lens barrel main body 30 of the embodiment 4 includes a protruding portion 34 protruding radially outward from the end on the side facing the cap 20. The protruding portion 34 covers the opening of the groove portion 23 in the embodiment 3 (see FIGS. 3 and 4). As a result, an annular space 28 is formed by the groove portion 23 and the protruding portion 34. In the present embodiment, the heater 61 is placed in the annular space 28. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature. In addition, since the protruding portion 34 is formed, the falling off of the heater 61 can be prevented from occurring.

### Embodiment 5

Next, an embodiment 5 which is another embodiment will be described. FIG. 5 is a schematic sectional view showing a cross section including the optical axis of a lens module according to the embodiment 5. Referring to FIGS. 5 and 3, the lens module 1 according to the embodiment 5 basically has the same configuration and effects as those of the embodiment 3. However, the lens module 1 of the embodiment 5 differs from the embodiment 3 in the structure of the cap 20.

Referring to FIG. 5, the cap 20 of the embodiment 5 includes a holding member 29A. In the present embodiment, a protruding portion protruding radially outward is formed at the end of the main body portion of the cap 20 on the side opposite to the lens barrel main body 30. On the other hand, the holding member 29A which has a hollow cylindrical shape and at the lens barrel main body 30 side end of which a protruding portion protruding radially inward is formed is disposed on the outer periphery side of the main body portion. Thus, an annular space 28 is formed between the main body portion of the cap 20 and the holding member 29A. In the present embodiment, the heater 61 is placed in the annular space 28. The heater 61 is supported from the outer periphery side by the holding member 29A. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature. The holding member 29A may be made of metal such as aluminum alloy, or may be made of resin. By using metal as the material constituting the holding member 29A, high durability can be obtained. By using resin having low thermal conductivity as the material constituting the holding member 29A, heat radiation from the cap 20 can be suppressed and the lens 10 is easily adjusted to a desired temperature.

### Embodiment 6

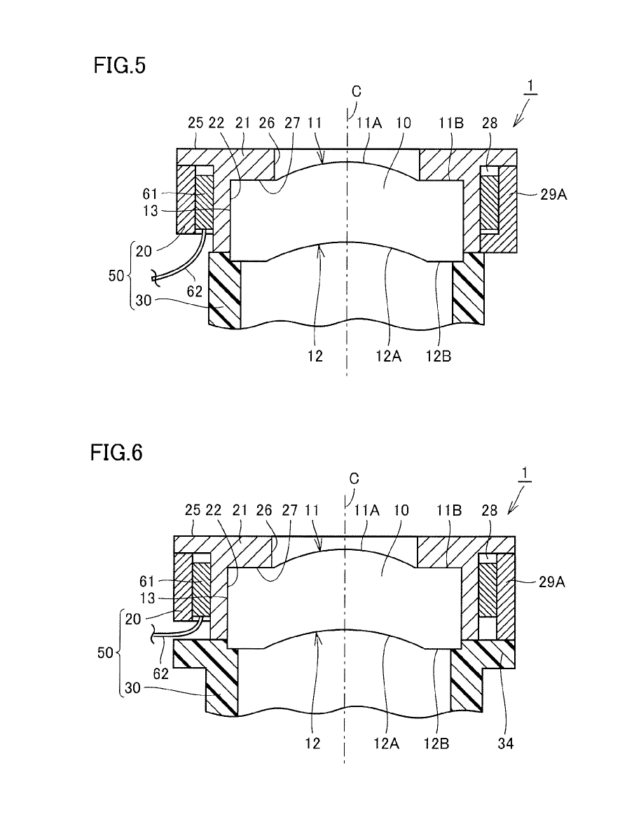

Next, an embodiment 6 which is another embodiment will be described. FIG. 6 is a schematic sectional view showing a cross section including the optical axis of a lens module according to the embodiment 6. Referring to FIGS. 6 and 5, the lens module 1 according to the embodiment 6 basically has the same configuration and effects as those of the embodiment 5. However, the lens module 1 of the embodiment 6 differs from the embodiment 5 in the structure of the lens barrel main body 30 and the cap 20 (holding member 29A).

Referring to FIG. 6, the lens barrel main body 30 of the embodiment 6 includes a protruding portion 34 protruding radially outward from the end on the side facing the cap 20. Further, a protruding portion as in the case of the embodiment 5 is not formed in the holding member 29A, and the holding member 29A has a hollow cylindrical shape. Thus, an annular space 28 is formed between the main body portion of the cap 20 and the holding member 29A. In the present embodiment, the heater 61 is placed in the annular space 28. The heater 61 is supported from the outer periphery side by the holding member 29A. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature.

### Embodiment 7

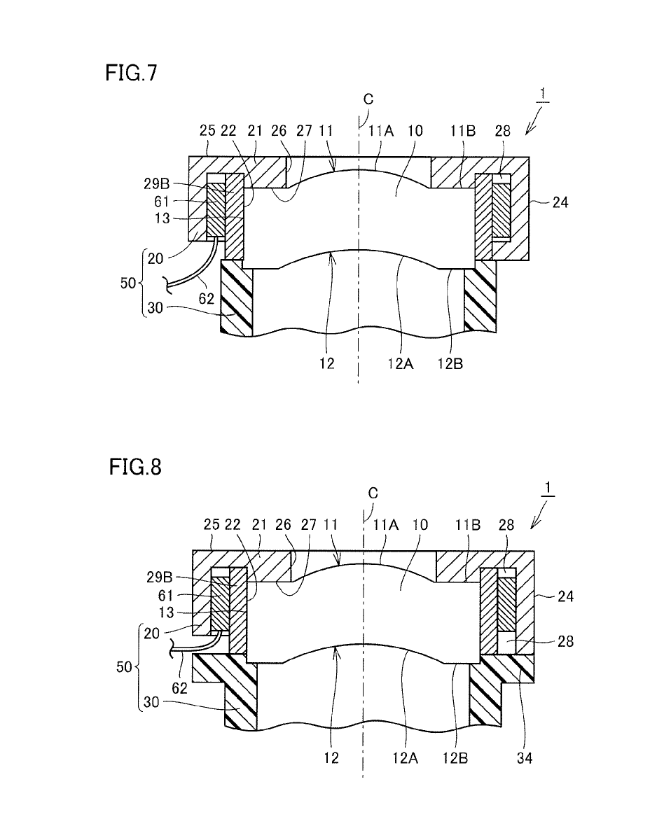

Next, an embodiment 7 which is another embodiment will be described. FIG. 7 is a schematic sectional view showing a cross section including the optical axis of a lens module according to the embodiment 7. Referring to FIGS. 7 and 3, the lens module 1 according to the embodiment 7 basically has the same configuration and effects as those of the embodiment 3. However, the lens module 1 of the embodiment 7 differs from the embodiment 3 in the structure of the cap 20.

Referring to FIG. 7, the cap 20 of the embodiment 7 includes a holding member 29B. In the present embodiment, a groove is formed in the inner peripheral surface of the cap 20, and the holding member 29B having a hollow cylindrical shape is disposed so as to cover the opening of the groove. Thus, an annular space 28 is formed between the main body portion of the cap 20 and the holding member 29B. In the present embodiment, the heater 61 is placed in the annular space 28. The heater 61 is supported from the inner periphery side by the holding member 29B. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature. The holding member 29B may be made of metal such as aluminum alloy, for example.

### Embodiment 8

Next, an embodiment 8 which is another embodiment will be described. FIG. 8 is a schematic sectional view showing a cross section including the optical axis of a lens module according to the embodiment 8. Referring to FIGS. 8 and 7, the lens module 1 according to the embodiment 8 basically has the same configuration and effects as those of the embodiment 7. However, the lens module 1 of the embodiment 8 differs from the embodiment 7 in the structure of the lens barrel main body 30 and the cap 20.

Referring to FIG. 8, the lens barrel main body 30 of the embodiment 8 includes a protruding portion 34 protruding radially outward from the end on the side facing the cap 20. In the cap 20, the lens barrel main body 30 side wall of the groove in the case of the embodiment 7 is not formed. The holding member 29B has a hollow cylindrical shape similarly to the case of the embodiment 7. As a result, an annular space 28 surrounded by the main body portion of the cap 20, the holding member 29B, and the protruding portion 34 of the lens barrel main body 30 is formed. In the present embodiment, the heater 61 is placed in the annular space 28. The heater 61 is supported from the inner periphery side by the holding member 29B. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature.

### Embodiment 9

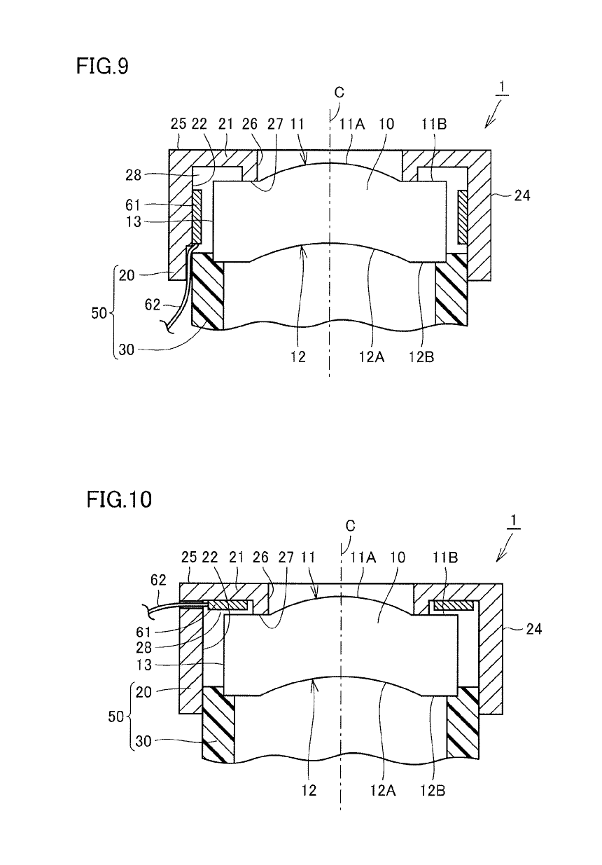

Next, an embodiment 9 which is another embodiment will be described. FIG. 9 is a schematic sectional view showing a cross section including the optical axis of a lens module according to the embodiment 9. Referring to FIGS. 9 and 1, the lens module 1 according to the embodiment 9 basically has the same configuration and effects as those of the embodiment 1. However, the lens module 1 of the embodiment 9 differs from the embodiment 1 in the arrangement of the heater 61.

Referring to FIG. 9, the heater 61 of the embodiment 9 is placed on the inner peripheral surface 22 of the cap 20. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature.

### Embodiment 10

Next, an embodiment 10 which is another embodiment will be described. FIG. 10 is a schematic sectional view showing a cross section including the optical axis of a lens module according to the embodiment 10. Referring to FIGS. 10 and 9, the lens module 1 according to the embodiment 10 basically has the same configuration and effects as those of the embodiment 9. However, the lens module 1 of the embodiment 10 differs from the embodiment 9 in the arrangement of the heater 61.

Referring to FIG. 10, the heater 61 of the embodiment 10 is placed on a surface of the protruding portion 21 of the cap 20 that faces the annular space 28 (a surface opposite to the outer edge region 11B as viewed from the annular space 28). Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature.

### Embodiment 11

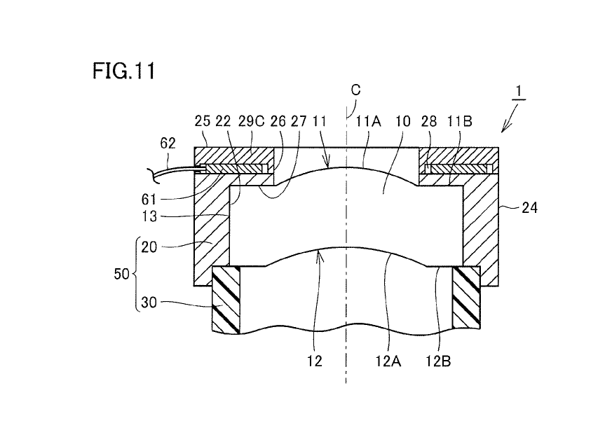

Next, an embodiment 11 which is another embodiment will be described. FIG. 11 is a schematic sectional view showing a cross section including the optical axis of a lens module according to the embodiment 11. Referring to FIGS. 11 and 3, the lens module 1 according to the embodiment 11 basically has the same configuration and effects as those of the embodiment 3. However, the lens module 1 of the embodiment 11 differs from the embodiment 3 in the structure of the cap 20.

Referring to FIG. 11, the cap 20 of the embodiment 11 includes a holding member 29C. In the present embodiment, the groove portion 23 is not formed in the cap 20. On the end face side of the main body portion of the cap 20 on the side opposite to the lens barrel main body 30, an annular holding member 29C having an annular groove opening toward the end surface is disposed. The holding member 29C is disposed such that the opening of the groove of the holding member 29C is covered by the main body portion of the cap 20. Thus, an annular space 28 is formed between the main body portion of the cap 20 and the holding member 29C. In the present embodiment, the heater 61 is placed in the annular space 28. Since, instead of placing the heater 61 outside the lens module 1 and adjusting the temperature of the lens 10 from the outside, the temperature of the lens 10 is adjusted (heated) by the heater 61 placed in the cap 20 in such a manner, the lens 10 is easily adjusted to a desired temperature. The holding member 29C may be made of metal such as aluminum alloy, or may be made of resin. By using metal as the material constituting the holding member 29C, high durability can be obtained. By using resin having low thermal conductivity as the material constituting the holding member 29C, heat radiation from the cap 20 can be suppressed and the lens 10 is easily adjusted to a desired temperature.

In the above embodiments, a case where a heater (film heater) is employed as a temperature adjustment device has been described, but a temperature adjustment device that can be employed is not limited to this, and for example, a thin planar heater, such as a rubber heater or a sheet heater, or a linear heater may be employed. In FIGS. 1 to 11, only one lens 10 is illustrated, but other lenses may exist behind the lens 10 (on the side facing the second lens surface 12). In the embodiment 1 and 2, a case where the heater 61, which is a temperature adjustment device, is disposed (fixed) on the outer peripheral surface 13 of the lens has been described. Instead of or in addition to this, a temperature adjustment device may be disposed (fixed) on the outer edge region (the outer edge region 11B, the outer edge region 12B) of the lens surface.

It is to be understood that the embodiments disclosed herein are illustrative in all respects, and are not limiting in any way. The scope of the present invention is not limited to the above description but is defined by the claims, and it is intended that all modifications within meaning and scope equivalent to the claims are included.

1. An infrared lens module comprising:
a lens that transmits infrared rays;
a lens barrel that holds the lens; and
a temperature adjustment device that is disposed on the lens and adjusts the temperature of the lens.

2. The infrared lens module according to claim 1, wherein a space is formed between the lens and the lens barrel.

3. The infrared lens module according to claim 1, wherein the temperature adjustment device is disposed on at least one of an outer peripheral surface of the lens and an outer edge region of the lens surface.

4. The infrared lens module according to claim 1, wherein the material constituting the lens is zinc sulfide.
